(19) United States
(12) Patent Application Publication
(10) Pub. No.: US 2014/0269531 A1
(43) Pub. Date: Sep. 18, 2014

(54) INTELLIGENT CONNECTION MANAGEMENT IN WIRELESS DEVICES

(71) Applicants: Michael Edward Smith Luna, San Jose, CA (US); Thomas Alan Donaldson, London (GB); Adam Koniak, Mountain View, CA (US)

(72) Inventors: Michael Edward Smith Luna, San Jose, CA (US); Thomas Alan Donaldson, London (GB); Adam Koniak, Mountain View, CA (US)

(73) Assignee: AliphCom, San Francisco, CA (US)

(21) Appl. No.: 13/831,529

(22) Filed: Mar. 14, 2013

(51) Int. Cl. H04L 5/00

(52) U.S. Cl. CPC H04L 5/0091
USPC 370/329

(57) ABSTRACT

Techniques associated with intelligent connection management in a wireless device are described, including receiving, at an output device, initiation data from a mobile device, the initiation data configured to initiate an operation associated with remote data, the mobile device configured to access a data plane packet and a control plane packet associated with the remote data using a cellular network, detecting a connection path available to the output device using an intelligent connection device coupled to the output device, determining, using connection profile data, whether the connection path is operable to access the data plane packet from a remote source, determining, using the connection profile data, whether the connection path is operable to access the control plane packet from the remote source, and accessing, using the output device, at least one of the data plane packet and the control plane packet.

### CROSS-REFERENCE TO RELATED APPLICATIONS

This application is related to co-pending U.S. patent application Ser. No. 13/802,442 (Attorney Docket No. ALI-190), filed Mar. 13, 2013, and entitled “Intelligent Connection Management in Wireless Devices,” which is incorporated by reference herein in its entirety for all purposes.

### FIELD OF THE INVENTION

The invention relates generally to electrical and electronic hardware, computer software, wired and wireless network communications, and computing devices. More specifically, techniques for intelligent connection management in wireless devices are described.

### BACKGROUND OF THE INVENTION

Wireless devices are widely used and are capable of connecting to networks, databases and other devices using an increasing number of connection paths (i.e., IEEE 802.11a/b/g/n (WiFi), other wireless local area network (WLAN), WiMax, ANT™, ZigBee®, Bluetooth®, ultra wideband, near field communication (NFC), mobile broadband (e.g., 4G, 3G or the like), other cellular networks, and the like). Yet conventional devices typically are not well suited to automatically and intelligently navigate changing network connections to optimize functionality.

Conventional devices also typically are not well suited to transfer functions between devices to take advantage of different connection capabilities and strengths. Switching functions between devices conventionally require significant manual operations by a user.

Thus, what is needed is a solution for intelligent connection management in wireless devices without the limitations of conventional techniques.

### BRIEF DESCRIPTION OF THE DRAWINGS

Various embodiments of the invention are disclosed in the following detailed description and the accompanying drawings:

FIG. 1 illustrates an exemplary intelligent connection device, according to some examples;

FIG. 2 illustrates an exemplary connection learning module, according to some examples;

FIGS. 3A-3B illustrate exemplary systems implementing intelligent connection management, according to some examples;

FIG. 4 illustrates an exemplary flow diagram for a technique for intelligent connection management, according to some examples;

FIG. 5 illustrates an exemplary computing platform suitable for intelligent connection management, according to some examples

FIG. 6 illustrates an exemplary system for obtaining data for intelligent connection management;

FIG. 7 illustrates an exemplary diagram of interactions between users and devices capable of intelligent connection management;

FIG. 8 illustrates an exemplary flow for transferring a call to a preferred device using intelligent connection management; and

FIG. 9 illustrates an exemplary flow for obtaining context data for intelligent connection management.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, then the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe®, AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Software and/or firmware implementations may be embodied in a non-transitory computer readable medium configured for execution by a general purpose computing system or the like. The described techniques may be varied and are not limited to the examples or descriptions provided.

Techniques for intelligent connection management in a wireless device are described. As described herein, a wireless device may be implemented with an intelligent connection device to determine available connection paths, and determine whether said available connection paths are optimally suited, or preferred, for performing various functions. As used herein, “available connection path” may refer to a wireless network available to be used by a device to connect to another nearby device, a network, the Internet, a remote device (e.g., remote server, remote database, or the like), or the like, for example, to receive, download, upload, or otherwise exchange data. In some examples, an intelligent connection device also may determine whether various other wireless devices in proximity with, or coupled to, said intelligent connection device are available and well suited for performing a function associated with an operation (e.g., telephone call, playing a media content, or the like) being performed by a compatible device, and to exchange data associated with said function to said wireless devices and said compatible device to seamlessly transfer said function from one device to another.

FIG. 1 illustrates an exemplary intelligent connection device, according to some examples. Here, intelligent connection device 100 includes antenna 102, connection path controller 104, connection learning module 106, intelligent communication facility 108, logic 110, memory 112 and sensor 118. As shown, intelligent connection device 100 may be configured to connect with wireless device 114 using intelligent communication facility 108. In some examples, connection path controller 104 may be configured to detect available connection paths (i.e., IEEE 802.11a/b/g/n (WiFi), other wireless local area network (WLAN), WiMax, ANT™, ZigBee®, Bluetooth®, ultra wideband, near field communication (NFC), mobile broadband (e.g., 4G, 3G or the like), other cellular networks, and the like). In some examples, connection path controller 104 may include one or more wireless controller circuits, including a WiFi controller, Bluetooth® controller, NFC controller, ultra wideband controller, or the like, without limitation. For example, connection path controller 104 may use a WiFi controller to detect when a WiFi signal is available for connection, and to determine a strength of the WiFi signal. In another example, connection path controller 104 may use a Bluetooth® controller to detect when a Bluetooth® signal is available for connection, and to determine a strength of the Bluetooth® signal. In some examples, connection path controller 104 may be configured to detect multipoint connection paths, for example, connection paths using two or more networks. For example, connection path controller 104 may determine that intelligent connection device 100 is in a Bluetooth® hotspot (i.e., a Bluetooth® network is readily accessible to intelligent connection device 100), and also determine that another network (e.g., WiFi, ultra wideband, or the like), which may better serve the data exchange requirements of an operation to be performed by intelligent connection device 100 (or another device coupled to intelligent connection device (not shown)), may be accessible using the Bluetooth® network. In some examples, connection path controller 104 may provide such multipoint connection path data to connection learning module 106 and intelligent communication facility 108 for further processing. In some examples, connection path controller 104 may be configured to detect and adjust to changing connection paths when different connection paths become available to intelligent connection device 100. For example, if a WiFi network disappears, but a different network becomes available (e.g., cellular, ultra wideband, or the like), connection path controller 104 may dynamically change from a connection path to another connection path, including adjusting one or more connections in a multipoint connection path, as intelligent connection device 100 continues to exchange or stream data.

In some examples, connection learning module 106 may be configured to generate connection profile data (e.g., connection profile data 214 in FIG. 2), and to use said connection profile data to determine a preferred connection path to use to perform an operation or function (e.g., connect or carry a telephone or video call, handle input/output for a telephone or video call, output audio data (e.g., associated with media content, a telephone call, or the like), output video data (e.g., associated with media content, a video conference call, or the like), stream data (e.g., using satellite radio, Internet or the like), download data, or otherwise handle data) in a situation or environment. In some examples, connection learning module 106 also may be configured to use said connection profile data to determine a preferred device to use to perform an operation or function in a situation or environment. In some examples, connection learning module 106 may be configured to determine a preferred connection path or preferred device to use to perform an operation or function based on data associated with user behavior in a situation or environment, as may be stored in a connection profile (e.g., connection profile data 214 in FIG. 2). Such data may be gathered using sensor 118, antenna 102, connection path controller 104, or other sources, without limitation. For example, sensor 118 may include one or more sensors configured to capture data associated with a user's location, environment and movement (e.g., accelerometer, thermometer, altimeter/barometer. light/infrared (“IR”) sensor, pulse/heart rate (“HR”) monitor, audio sensor (e.g., microphone, transducer, or others), global positioning system (GPS) receiver, location-based service sensor (e.g., sensor for determining location within a cellular or micro-cellular network, which may or may not use GPS or other satellite constellations for fixing a position), motion detection sensor, environmental sensor, chemical sensor, other electrical sensor, other mechanical sensor, or the like). In some examples, sensor 118 may provide such data to connection learning module 106, and connection learning module 106 may use such data to determine parameters associated with a user's behavior and environment. For example, sensor 118 may provide data to connection learning module 106 associated with environmental temperature, movement, heart rate, location, and other data, from which connection learning module 106 may derive data indicating that a user is sitting in a room alone. In this example, connection learning module 106 also may receive data from antenna 102 indicating wireless device 114 is within a threshold proximity of intelligent connection device 100. As used herein, “threshold proximity” may refer to an actual distance or may be based upon a signal strength, for example, of a mobile device (e.g., wireless device 114 or the like), and may be pre-programmed into intelligent connection device 100 or dynamically determined based upon parameters (e.g., whether one or more types of signals being received from a mobile device is strong enough to carry out a communication operation, or data operation, or the like). In this example, connection learning module 106 also may receive data from connection path controller 104 indicating a presence of an available network (e.g., WiFi, or other wireless local area network, or the like) configured to access Internet data, either directly or indirectly (i.e., through a multipoint connection using another local network (e.g., Bluetooth®, NFC, or the like)). Also in this example, connection learning module 106 may receive data from intelligent communication facility 108 indicating wireless device 114 has a compatible communication capability (i.e., both intelligent connection device 100 and wireless device 114 may communicate using Bluetooth® protocol). In some examples, connection learning module 106 may store such data from sensor 118, antenna 102, connection path controller 104 and intelligent communication facility 108 in connection profile data (e.g., connection profile data 214 in FIG. 2), and use said connection profile data to determine, for example, another device (e.g., a speaker, speakerphone, or other device capable of audio output) coupled to intelligent connection device 100 may be a preferred device for performing the function of outputting audio from, or routing to, a telephone call received by wireless device 114 given data indicating a user of wireless device 114 is alone in an office wherein the another device may be configured to project said audio output more clearly. In another example, connection profile data may be used to determine, for example, that a more a device capable of more private audio output (e.g., headphones, headset, or the like) may be a preferred device for performing the function of outputting audio from, or routing to, a telephone call received by wireless device 114 given data indicating a user of wireless device 114 is in a public space with others around. In some examples, connection learning module 106 may use such gathered or captured data along with previously stored connection profile data to determine a preferred connection path or preferred device to use to perform an operation or function. Such derived data (i.e., data derived from gathered data) also may be stored in a connection profile (e.g., connection profile data 214 in FIG. 2, or the like) along with other data to inform a determination of a preferred connection path or preferred device to use to perform an operation or function.

In some examples, connection learning module 106 may be configured to determine a preferred connection path or preferred device to use to perform an operation or function also based on data associated with characteristics of a connection path. For example, connection profile data may include pre-programmed data associated with characteristics of various types of networks (e.g., WiFi and faster mobile broadband (i.e., 4G) networks may be preferred for handling Internet data, other mobile broadband or cellular networks (i.e., 3G) may be preferred for handling voice data (i.e., associated with a telephone call), Bluetooth® network may be preferred for handling data exchange between proximate devices (i.e., close enough for short range communication using radio transmissions in approximately 2400-2480 MHz band, or other range for two Bluetooth®-enabled devices to communicate), ultra wideband may be preferred for handling high bandwidth data exchange between proximate devices (i.e., close enough for two ultra wideband-enabled devices to conununicate), NFC may be preferred for handling data exchange between even closer proximate devices (i.e., within a few centimeters or inches), or the like). In some examples, connection learning module 106 may be configured to determine a preferred connection path or preferred device to use to perform an operation or function based on other pre-programmed connection preference data (e.g., functional capabilities of various types of devices (e.g., a television or other type of audio-video display device may be preferred for operations involving both audio and video (e.g., streaming a movie, videochat, video conference call, or the like), a high-end speaker may be preferred over a television for audio output with no related video output or for playing a particular type of music, or the like), a priority associated with various types of connection paths (e.g., Bluetooth® may be preferred over NFC, WiFi may be preferred over mobile broadband, direct connection paths may be preferred over multipoint connection paths, a strong mobile broadband signal may be preferred over a weak WiFi signal, or the like), a priority associated with various types of devices, or the like). In an example, connection profile data may be used to determine that a device (e.g., a speaker, speakerphone, display, other device capable of audio or video output, or the like) coupled to intelligent connection device 100 is preferred for performing all data functions (e.g., including data plane and control plane functions) for playing music using an application implemented on wireless device 114 (see, e.g., FIGS. 3A-3B) given data indicating that an available connection path accessible to said device and appropriate for performing said data functions (e.g., WiFi, a multipoint path accessing WiFi, or the like). In another example, connection profile data may be used to determine that wireless device 114 is a preferred device for performing said data functions given additional connection capabilities of wireless device 114 (i.e., wireless device 114 may be capable of accessing a cellular network, where other devices are not). In other examples, the quantity, type, function, structure, and configuration of the elements shown may be varied and are not limited to the examples provided.

In some examples, antenna 102 may be implemented as a receiver, transmitter, or transceiver, configured to detect and generate radio waves, for example, to and from electrical signals. In some examples, antenna 102 may be configured to detect radio signals across a broad spectrum, including licensed and unlicensed bands (e.g., WiFi, Bluetooth®, NFC, ultra wideband, or other bands). In some examples, antenna 102 may be configured to generate data associated with a radio signal or energy from wireless device 114, or other wireless devices (e.g., speakers 306 and 316 and mobile devices 304 and 314 and display 114 in FIGS. 3A-3B, and the like), including proximity data (i.e., data associated with a proximity of wireless device 114) and location data (i.e., data associated with a location (e.g., direction, position, either in a room or other environment, and the like) of wireless device 114). In some examples, antenna 102 may determine a proximity of wireless device 114 using an intensity of a radio signal or energy emitted by wireless device 114, for example, as may be caused by a wireless data exchange being performed by wireless device 114 (e.g., downloading an electronic mail message (“email”) or other data, receiving a push notification or other data, sending or receiving a wireless signal to detect a connection path, or the like). In some examples, antenna 102 may be configured to generate, and communicate to intelligent conmmunication facility 108, data associated with a proximity and location of wireless device 114. As used herein, “facility” refers to any, some, or all of the features and structures that are used to implement a given set of functions. In some examples, intelligent communication facility 108 may be configured to communicate with wireless device 114 automatically once wireless device 114 comes within a certain threshold proximity of intelligent connection device 100, and makes this threshold proximity determination using data gathered by antenna 102. An example of an intelligent communication facility is described in co-pending U.S. patent application Ser. No. XX/XXX,XXX, filed February YY, 2013, entitled “Intelligent Device Connection for Wireless Media Ecosystem.” In other examples, the quantity, type, function, structure, and configuration of the elements shown may be varied and are not limited to the examples provided.

In some examples, logic 110 may be implemented as firmware or application software that is installed in a memory (e.g., memory 112, memory 506 in FIG. 5, or the like) and executed by a processor (e.g., processor 504 in FIG. 5). Included in logic 110 may be program instructions or code (e.g., source, object, binary executables, or others) that, when initiated, called, or instantiated, perform various functions. In some examples, logic 110 may provide control functions and signals to other components of intelligent connection device 100, including to antenna 102, connection path controller 104, connection learning module 106, intelligent communication facility 108, sensor 118, or other components. For example, logic 310 may be configured to send control signals to intelligent communication facility 308 to transfer, transmit, or receive data, to and from antenna 302, connection path controller 104, media configuration module 306, or a memory (e.g., memory 312, memory 506 in FIG. 5, or the like). In other examples, the quantity, type, function, structure, and configuration of the elements shown may be varied and are not limited to the examples provided.

FIG. 2 illustrates an exemplary connection learning module, according to some examples. Here, connection learning module 200 includes data interface 202, connection profile generator 204 and connection profile manager 206. Like-numbered and named elements may describe the same or substantially similar elements as those shown in other descriptions. In some examples, data interface 202 may be configured to receive sensor data 210 (e.g., from sensor 118 in FIG. 1) and connection path data 208 (e.g., from connection path controller 104 in FIG. 1). In other examples, data interface 202 may be configured to receive other types of data from other sources (e.g., antenna 102, memory 112 and intelligent communication facility 108 in FIG. 1, input/output devices 216, or the like). In some examples, data interface 202 may be configured to provide connection path data 208, sensor data 210, and other types of data, to connection profile generator 204.

In some examples, connection profile generator 204 may be configured to generate connection profile data (e.g., connection profile data 214). In some examples, connection profile data 214 may be associated with connection preferences (e.g., in a situation or environment). In some examples, connection profile generator 204 may generate connection profile data 214 using captured or gathered data (e.g., connection path data 208, sensor data 210, or the like), for example, associated with a user's behavior, location and/or environment, as described herein. In some examples, connection profile data 214 may be parameters derived from such captured or gathered data. For example, connection profile generator 204 may be configured to derive from sensor data 210 and connection path data 208 that a user of a device coupled to connection learning module 200 is in an outdoor space, with other people present, and both WiFi and Bluetooth® connection paths available. In this example, connection profile generator 204 may generate additional connection profile data indicating that a Bluetooth®-enabled headset, headphones, or other private audio output device, may be preferred for handling audio or voice data associated with a telephone call in such an outdoor, public setting. In this example, connection profile generator 204 also may generate connection profile data indicating that both data plane and control plane functions for streaming media content may be performed by a WiFi-enabled media player device using an available WiFi connection path. In other examples, connection profile generator 204 may generate connection profile data 214 using pre-programmed data associated with characteristics of one or more connection paths, or other pre-programmed connection preference data, as described herein. In some examples, connection profile data 214 may be used to determine a preferred connection path to use to perform an operation or function (e.g., connect or carry a telephone or video call, handle input/output for a telephone or video call, output audio data (e.g., associated with media content, a telephone call, or the like), output video data (e.g., associated with media content, a video conference call, or the like), stream data (e.g., using satellite radio, Internet or the like). download data, or otherwise handle data) in a situation or environment, as described herein.

In some examples, connection profile manager 206 may be configured to access the connection profile data and provide the connection profile data to the intelligent connection device. For example, connection profile manager 206 may be configured to access connection profile data 214 stored in storage 212 for use by input/output devices 216 (e.g., intelligent communication facility 108 in FIG. 1, another device, or the like). In some examples, connection profile manager 206 may be configured to determine which connection profiles should be accessed and used for determining preferred connection paths or devices based on connection path data 208, sensor data 210, or other data associated with a user's behavior or environment. In some examples, connection profile manager 206 may configure data generated by connection profile generator 204 for storage in connection profiles (e.g., in storage 212). In other examples, the quantity, type, function, structure, and configuration of the elements shown may be varied and are not limited to the examples provided.

FIGS. 3A-3B illustrate exemplary systems implementing intelligent connection management, according to some examples. Here, system 300 includes network 302, mobile device 304, speaker 306, intelligent connection device 308, and system 310 includes network 312, mobile device 314, speaker 316 and intelligent connection device 318. Like-numbered and named elements may describe the same or substantially similar elements as those shown in other descriptions. In some examples, speakers 306 and 316 may be implemented as any device configured to output audio, and may include other functional capabilities (e.g., communication functions, device control functions, sensor functions, or the like), as described herein. In some examples, mobile devices 304 and 314 may be implemented as a mobile communication device, mobile computing device tablet computer, or the like, without limitation. In some examples, mobile devices 304 and 314 may be configured with mobile broadband capabilities such that mobile devices 304 and 314 may perform both data plane and control plane functions using a mobile broadband connection path. As used herein, a control plane function may include routing functions (i.e., selecting paths in a network along which to send network traffic (i.e., data packets)), such as generating a network map or routing table, for example, to define routes for incoming data packets, including, without limitation, a list of destination addresses and outgoing interfaces associated with them). In some examples, control plane functions may also include defining certain packets to be discarded, and certain other packets to be treated preferentially. In some examples, control plane functions also may include management plane functions (i.e., handling of data associated with network management). As used herein, a data plane function may include receiving and processing an inbound data packet and forwarding said inbound data packet to an appropriate outgoing interface. In some examples, a data plane function may include forwarding certain packets to the control plane (i.e., packets destined for the router, including routing protocol updates, packets needing special processing, or the like, without limitation).

In system 300, speaker 306 may receive data configured to initiate an operation (e.g., stream media content, download media content, stream voice over Internet Protocol (VoIP) content, or the like) involving streaming, downloading, or otherwise accessing remote data (i.e., non-local data or data accessible over a remote network, such as Internet data, as opposed to a short-range network, as described herein), or the like) from mobile device 304 (e.g., using a short-range network, such as Bluetooth®, ultra wideband, NFC, or the like). In some examples, said operation may involve accessing remote data (i.e., data from a remote network or device, as described herein, such as Internet data), for example, using longer-range communication protocols (e.g., satellite, mobile broadband, GPS, WiFi, and the like). In some examples, intelligent connection device 308 may be configured to determine whether there is an available WiFi network, or other network configured to support data plane and control plane functions for said remote data exchange, which may be accessible using network 302. In some examples, where intelligent connection device 308 determines that a WiFi network is an available connection path for speaker 306, intelligent connection device 308 may send a control signal to speaker 306 to take over both data plane and control plane functions associated with an operation initiated by mobile device 304. For example, if mobile device 304 sends initiation data to speaker 306 associated with streaming a satellite radio feed, intelligent connection device 308 may determine, for example using connection profile data, as described herein, that speaker 306 is operable to access control plane data associated with streaming said satellite radio feed from network 302 based on the availability of a WiFi signal (i.e., of sufficient signal strength). In this example, intelligent connection device 308 also may determine, also using connection profile data, that speaker 306 is operable to access data plane data associated with streaming said satellite radio feed using network 302 based on the availability of a WiFi signal (i.e., of sufficient signal strength). In some examples, intelligent connection device 308, based on these determinations, may send a control signal to speaker 306 to take over said control plane and data plane functions. In some examples, where mobile device 304 is performing said control plane and data plane functions, intelligent connection device 308 also may send a control signal to mobile device 304 to cease performing said control plane and data plane functions. In other examples, the quantity, type, function, structure, and configuration of the elements shown may be varied and are not limited to the examples provided.

In system 310, speaker 316 may receive data configured to initiate an operation (e.g., stream media content, download media content, stream voice over Internet Protocol (VoIP) content, or the like) involving streaming, downloading, or otherwise accessing remote data (i.e., non-local data or data accessible over a network), or the like) from mobile device 314 (e.g., using a short-range network, such as Bluetooth®, ultra wideband. NFC, or the like). In some examples, said operation may involve accessing remote data (i.e., data from a remote network or device, as described herein, such as Internet data). In some examples, intelligent connection device 318 may be configured to determine whether there is an available WiFi network, or other network configured to support data plane and control plane functions for said remote data exchange, which may be accessible using network 312. In some examples, where intelligent connection device 318 determines that available connection paths for speaker 316 include only short-range networks (e.g., Bluetooth®, ultra wideband, NFC, or the like), without any direct or multipoint connection paths available to speaker 316 configured to access said remote data using network 312, intelligent connection device 318 may determine speaker 316 unsuitable to access data plane and control plane data using network 312 associated with an operation initiated by mobile device 314. In some examples, intelligent connection device 318 may determine that mobile device 314 has a connection capability that speaker 316 may not have (e.g., mobile device 314 can access a mobile broadband or other cellular network that speaker 316 may not), and thus mobile device 314 may access the control plane and data plane data using network 312, feeding said data to speaker 316 to perform an operation, for example streaming a satellite radio station, streaming a movie over the Internet, outputting voice data associated with a telephone call, or the like, without limitation. In other examples, the quantity, type, function, structure, and configuration of the elements shown may be varied and are not limited to the examples provided.

FIG. 4 illustrates an exemplary flow diagram for a technique for intelligent connection management, according to some examples. Here, flow diagram 400 begins with receiving, at an output device, initiation data from a mobile device, the initiation data configured to initiate an operation associated with remote data (402). In some examples, initiation data may be configured to initiate an operation (e.g., stream media content, download media content, stream voice over Internet Protocol (VoIP) content, or the like) involving streaming, downloading, or otherwise accessing remote data (i.e., non-local data or data accessible over a network), or the like). In some examples, an output device receiving initiation data may include, or be coupled to, an intelligent connection device (e.g., intelligent connection device 100 in FIG. 1), as described herein. Once initiation data is received, a connection path available to the output device may be detected using an intelligent connection device coupled to the output device (404). In some examples, an intelligent connection device coupled to an output device may be configured to determine connection paths available to said output device, as described herein, and further to determine which, if any, of the available connection paths may be preferred for performing various functions (e.g., WiFi and faster mobile broadband (i.e., 4G) networks may be preferred for handling Internet data, other mobile broadband or cellular networks (i.e., 3G) may be preferred for handling voice data (i.e., associated with a telephone call), Bluetooth® network may be preferred for handling data exchange between proximate devices (i.e., close enough for short range communication using radio transmissions in Bluetooth®), ultra wideband may be preferred for handling high bandwidth data exchange between proximate devices (i.e., close enough for two ultra wideband-enabled devices to communicate), NFC may be preferred for handling data exchange between even closer proximate devices (i.e., within a few centimeters or inches), or the like), as described herein. Once an available connection path is detected, a determination may be made, using connection profile data, whether the connection path is operable to access a data plane packet from a remote source (406), the data plane packet associated with said remote data associated with said operation initiated by said mobile device. In some examples, the remote source may comprise a database, a server, a network, the Internet, or the like, accessible over a remote network, as opposed to a short-range network (e.g., Bluetooth®, NFC, ultra wideband, or the like). Another determination also may be made, also using connection profile data, whether the connection path is operable to access a control plane packet from the remote source (408). In some examples, said data plane packet may be a data packet forwarded in the data plane. In some examples, said control plane packet may be a data packet destined for a router, for example, for use in control plane functions. In some examples, determinations regarding the suitability of a connection path for various operations or functions may be based on connection profile data, which may include data associated with characteristics of various connection paths, or other pre-programmed connection preference data, as described herein. In other examples, connection profile data also may include captured or gathered data associated with a user's behavior or environment, as described herein. After determining whether the connection path is operable to access the data plane packet and/or the control plane packet, the output device may be used to access at least one of the data plane packet and the control plane packet (410). For example, if a determination is made that the connection path available to the output device is operable to access the data plane packet, then the output device may be used to access the data plane packet. In another example, if a determination is made that the connection path available to the output device is operable to access the control plane packet, then the output device may be used to access the control plane packet. In other examples, the above-described process may be varied in steps, order, function, processes, or other aspects, and is not limited to those shown and described.

FIG. 5 illustrates an exemplary computing platform suitable for intelligent connection management, according to some examples. In some examples, computing platform 500 may be used to implement computer programs, applications, methods, processes, algorithms, or other software to perform the above-described techniques. Computing platform 500 includes a bus 502 or other communication mechanism for communicating information, which interconnects subsystems and devices, such as processor 504, system memory 506 (e.g., RAM, etc.), storage device 508 (e.g., ROM, etc.), a communication interface 513 (e.g., an Ethernet or wireless controller, a Bluetooth controller, etc.) to facilitate communications via a port on communication link 521 to communicate, for example, with a computing device, including mobile computing and/or communication devices with processors. Processor 504 can be implemented with one or more central processing units (“CPUs”), such as those manufactured by Intel® Corporation, or one or more virtual processors, as well as any combination of CPUs and virtual processors. Computing platform 500 exchanges data representing inputs and outputs via input-and-output devices 501, including, but not limited to, keyboards, mice, audio inputs (e.g., speech-to-text devices), user interfaces, displays, monitors, cursors, touch-sensitive displays, LCD or LED displays, speakers, media players and other I/O-related devices.

According to some examples, computing platform 500 performs specific operations by processor 504 executing one or more sequences of one or more instructions stored in system memory 506, and computing platform 500 can be implemented in a client-server arrangement, peer-to-peer arrangement, or as any mobile computing device, including smart phones and the like. Such instructions or data may be read into system memory 506 from another computer readable medium, such as storage device 508. In some examples, hard-wired circuitry may be used in place of or in combination with software instructions for implementation. Instructions may be embedded in software or firmware. The term “computer readable medium” refers to any non-transitory medium that participates in providing instructions to processor 504 for execution. Such a medium may take many forms, including but not limited to, non-volatile media and volatile media. Non-volatile media includes, for example, optical or magnetic disks and the like. Volatile media includes dynamic memory, such as system memory 506.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 502 for transmitting a computer data signal.

In some examples, execution of the sequences of instructions may be performed by computing platform 500. According to some examples, computing platform 500 can be coupled by communication link 521 (e.g., a wired network, such as LAN, PSTN, or any wireless network) to any other processor to perform the sequence of instructions in coordination with (or asynchronous to) one another. Computing platform 500 may transmit and receive messages, data, and instructions, including program code (e.g. application code) through communication link 521 and communication interface 513. Received program code may be executed by processor 504 as it is received, and/or stored in memory 506 or other non-volatile storage for later execution.

In the example shown, system memory 506 can include various modules that include executable instructions to implement functionalities described herein. In the example shown, system memory 506 includes a connection learning module 510 configured to generate connection profiles and manage performance of functions by a wireless device based on said connection profiles, as described herein. System memory 506 also may include intelligent communication module 512, which may be configured to provide one or more of the intelligent communication functions described herein (see, e.g., intelligent communication facilities 108 in FIG. 1).

In some embodiments, speakers 306 and 316 and wireless devices 304 and 314 of FIGS. 3A-3B can communicate (e.g., wired or wirelessly) with each other, or with other compatible devices. In some cases, speakers 306 and 316, wireless devices 304 and 314, or any networked computing device (not shown) in communication with speakers 306 and 316 or wireless devices 304 and 314, can provide at least some of the structures and/or functions of any of the features described herein. As depicted in FIGS. 1-4 herein, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIGS. 1-4 can represent one or more algorithms. Or, at least one of the elements can represent a portion of logic including a portion of hardware configured to provide constituent structures and/or functionalities.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, intelligent communication module 512, including one or more components, can be implemented in one or more computing devices that include one or more circuits. Thus, at least one of the elements in FIGS. 1-4 can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

FIG. 6 illustrates an exemplary system for obtaining data for intelligent connection management. Here, system 600 includes intelligent connection device 602, wireless device 604, memory 604a, network 606, servers 608-612 and storage 608a-612a. Like-numbered and named elements may describe the same or substantially similar elements as those shown in other descriptions. In some examples, intelligent connection device 602 and wireless device 604 may obtain data stored in one or more of storage 608a-612a, including context data (e.g., environmental data, statistical data, regional or location-related data, device identification, user identification, contact information, calendar information, public database information, and the like) associated with a user or an operation, by accessing servers 608-612, either directly, or through network 606. In some examples, intelligent connection device 602 may be configured to access environmental or other data associated with a location (e.g., a landmark, a business, a home, an office, a public space, and the like) stored in storage 608a through network 606 and server 608 to derive parameters for determining or selecting a preferred device or preferred connection path, as described herein. For example, intelligent connection device 602 may use data from storage 608a to derive one or more parameters associated with a location of the user (e.g., public or private, likelihood of high ambient noise (e.g., an entertainment venue, nightclub, restaurant, or the like) or likelihood of low ambient noise (e.g., library, doctor's office, or the like), indoor or outdoor, high or low altitude, urban or rural, and the like), for use in selecting a preferred device or preferred connection path for performing an operation. In other examples, intelligent connection device 602 may be configured to access data (e.g., data associated with identification, contact, or calendar information, or the like) stored in storage 610a through server 610, for example, to derive one or more parameters associated with a user. In still other examples, intelligent connection device 602 may be configured to access data (i.e., context data) from wireless device 604. In some examples, wireless device 604 may, in turn, access said data from memory 604a. In other examples, wireless device 604 may access said data from a remote source, such as server 612 and storage 612a. In some examples, data representing contact information may include, without limitation, category data (i.e., type of contact (e.g., family member, co-worker, supervisor, friend, acquaintance, doctor, lawyer, and the like)), identification data (i.e., name, phone number, address, email, and the like), and other types of data that may be accessed from a contact database or social network database. In some examples, category data may indicate one or more parameters associated with a contact (e.g., personal or private for immediate family members, doctor, personal lawyer, or close friend, work-related, team-related, client-related, and the like). In some examples, data representing calendar information may include data indicating one or more parameters associated with calendar entries (e.g., work or team meeting or conference call, including intended participant information (e.g., names, local and/or remote (i.e., different site, office, state, or country), and the like), events, personal appointments, and the like, including data associated with a type (e.g., family, work, public, private, and the like), a status (e.g., confirmed, tentative, canceled, overdue, completed, and the like), a location, or other information (e.g., urgent, holiday, and the like). In some examples, intelligent connection device 602 may be configured to cross-reference one or more parameters derived from one type of data may be cross-referenced with another type of data in order to determine a preferred device or preferred connection path (see FIG. 7). In other examples, the quantity, type, function, structure, and configuration of the elements shown may be varied and are not limited to the examples provided.

FIG. 7 illustrates an exemplary diagram of interactions between users and devices capable of intelligent connection management. Here, diagram 700 depicts room 701, users 702-0-702-2 and 704, speaker 706, intelligent connection device 708, headset 710, and mobile devices 712-714. Like-numbered and named elements may describe the same or substantially similar elements as those shown in other descriptions. In some examples, mobile device 712 may include intelligent connection device 712a, calendar application 712b and contacts application 712c. In some examples, mobile device 714 may include similar components and applications as mobile device 712. In some examples, speaker 706 may be implemented as any type of input/output audio device. In some examples, speaker 706 may be coupled to a telephony system (not shown) configured to connect and handle input/output functions for conference calls (e.g., using public-switched telephone network, voice over IP (VoIP), fiber optics, or the like). In some examples, speaker 706 also may be coupled to a display (not shown) configured to output video, including for a video conference call. In some examples, speaker 706 may include, or be coupled to, intelligent connection device 708. In some examples, intelligent connection device 712a may be configured to detect an incoming call to mobile device 712, for example from mobile device 714. In some examples, intelligent connection device 712a may be configured to identify user 704 as the caller using identifying data from mobile device 714 (e.g., telephone number, name, or the like). In some examples, intelligent connection device 712a also may be configured to obtain context data associated with the incoming call from mobile device 714, including contact information (i.e., category data and other identification data) using contacts application 712c and calendar information using calendar application 712b, and to derive one or more parameters from said data to determine or select a preferred device with which to answer said incoming call. In some examples, calendar application 712b and contacts application 712c may provide data from local or system memory (not shown) implemented in mobile device 712. In other examples, calendar application 712b and contacts application 712c may obtain data from a remote source (e.g., remote database, remote storage, or the like) using a network connection.

In some examples, intelligent connection device 712a may use one or more parameters derived from context data, including calendar and contact information, among other data, to determine whether headset 710 or speaker 706 is a preferred device for answering or connecting said incoming call from mobile device 714. In an example, one or more parameters may indicate that room 701 is a conference room in an office, that there is a team conference call that began just a few minutes ago in which users 702-0-702-2 are participating using speaker 706, that mobile device 714 is associated with user 704, and that user 704 is another intended participant in said team conference call. In some examples, a parameter may be derived from data received in response to a query sent from intelligent connection device 712a to intelligent connection device 708, for example, to determine whether speaker 706 is handling input/output audio for an ongoing conference call. In this example, intelligent connection device 712a may determine using one or more of these or other parameters that speaker 706 is a preferred device for connecting said incoming call, and may route said incoming call to intelligent connection device 708 (or a telephony system coupled to speaker 706 and intelligent connection device 708) to be joined with the ongoing conference call. In some examples, after said incoming call is joined with said ongoing conference call, if user 704 may enter room 701 while said conference call is still in progress, intelligent connection device 708 automatically may detect mobile device 714 breaching or crossing a proximity threshold, or otherwise determine that mobile device 714 has entered room 701, and may disconnect said incoming call from mobile device 714. In another example, one or more parameters may indicate that room 701 is a conference room in an office, that there is a team conference call that began just a few minutes ago in which users 702-0-702-2 are participating using speaker 706, that mobile device 714 is associated with user 704, and that user 704 is a family member, or other private contact, of user 702-0. In this example, intelligent connection device 712a may determine using one or more of these or other parameters that headset 710 is a preferred device for connecting said incoming call from mobile device 714. In still other examples, the quantity, type, function, structure, and configuration of the elements shown may be varied and are not limited to the examples provided.

FIG. 8 illustrates an exemplary flow for transferring a call to a preferred device using intelligent connection management. Here, flow 800 begins with detecting, using an intelligent connection device implemented in a wireless device, a call incoming to the wireless device (802). An intelligent connection device may be configured to automatically obtain context data associated with the call (804), in response to detecting the call. An intelligent connection device also may be configured to automatically derive one or more parameters associated with the call using the context data (806), and to select a compatible device as a preferred device to connect the call using the one or more parameters (808). In some examples, an intelligent connection device may determine compatibility using an intelligent communication facility, as described herein. In some examples, a preferred device may be selected using data from a connection learning module, as described herein. Once a compatible device is selected as a preferred device, operational data may be sent to the compatible device, the operational data configured to transfer the call to the compatible device (810). For example, the compatible device may be a speaker and telephony system, and the one or more parameters may indicate the call should be joined with a conference call, in which case an intelligent connection device may send query data to the speaker and telephony system (i.e., coupled to another intelligent connection device) to determine whether the appropriate conference call is being carried by the telephony system and whether the call may be joined with the conference call. In another example, the one or more parameters may indicate that the caller is a private caller (e.g., family member, doctor, lawyer, or the like), prompting an intelligent connection device may select a headset as a preferred device to connect the call, in which case said intelligent connection device may send operational data configured to prompt said headset to connect or receive the call, including, without limitation, routing call data and data configured to initiate or turn on related functions. In other examples, the above-described process may be varied in steps, order, function, processes, or other aspects, and is not limited to those shown and described.

FIG. 9 illustrates an exemplary flow for obtaining context data for intelligent connection management. Here, flow 900 begins with identifying a caller associated with a call (902). In some examples, identifying a caller may include receiving identifying data associated with an incoming call. In some examples, additional identifying information or context data associated with the call and the caller may be obtained. In some examples, category data associated with the caller may be obtained using a contacts database, the category data indicating whether the caller is a private caller (904). In some examples, identifying data received with an incoming call may be cross-referenced with data from a contacts database (e.g., using contacts application 712c in FIG. 7, or the like) to obtain additional identifying information, such as category data, as described herein. Then, calendar data associated with the caller also may be obtained, the calendar data indicating whether the caller is an intended conference call participant (906). In some examples, said calendar data may be obtained from a calendar database (e.g., using calendar application 712b in FIG. 7, or the like). In some examples, additional context data also may be obtained from local or remote databases, including, without limitation, environmental and location data. Then, one or more parameters may be derived from the context data (e.g., category data, calendar data, and the like). For example, it may be determined whether the caller is a private caller (908). If the call is from a private caller (e.g., a family member, a doctor, a lawyer, or the like), then the call may be connected using a preferred device being configured to connect a private call (910), for example, a headset or personal mobile device. If the call is not from a private caller, it may then be determined whether the caller is an intended participant in a conference call (912). If yes, the call may be routed to a telephony system (i.e., including a speaker and microphone system) configured to handle input/output functions for the conference call (914), for example, after determining the conference call is ongoing and being carried by said telephony system, as described herein. If the caller is not an intended conference call participant, then the call may be connected using a default device (916). In an example, a default device may be a wireless device to which the call was originally directed. In another example, a default device may be a headset for which a user has preset a preference for using to receive calls whenever the headset is turned on. In other examples, the above-described process may be varied in steps, order, function, processes, or other aspects, and is not limited to those shown and described.

The foregoing description, for purposes of explanation, uses specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment can readily be interchanged with other embodiments. Notably, not every benefit described herein need be realized by each embodiment of the present invention; rather any specific embodiment can provide one or more of the advantages discussed above. In the claims, elements and/or operations do not imply any particular order of operation, unless explicitly stated in the claims. It is intended that the following claims and their equivalents define the scope of the invention. Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method, comprising:
receiving, at an output device, initiation data from a mobile device, the initiation data configured to initiate an operation associated with remote data, the mobile device configured to access a data plane packet and a control plane packet associated with the remote data using a cellular network;
detecting a connection path available to the output device using an intelligent connection device coupled to the output device;
determining, using connection profile data, whether the connection path is operable to access the data plane packet from a remote source;
determining, using the connection profile data, whether the connection path is operable to access the control plane packet from the remote source; and
accessing, using the output device, at least one of the data plane packet and the control plane packet.

2. The method of claim 1, wherein accessing the at least one of the data plane packet and the control plane packet comprises accessing the data plane packet after determining the connection path is operable to access the data plane function from the remote source.

3. The method of claim 1, wherein accessing the at least one of the data plane packet and the control plane packet comprises accessing the control plane packet after determining the connection path is operable to access the control plane packet from the remote source.

4. The method of claim 1, wherein the remote data comprises Internet data, and the remote source comprises a remote server.

5. The method of claim 1, wherein the connection profile data comprises data associated with one or more connection preferences.

6. The method of claim 1, wherein the connection profile data comprises sensor data associated with a user behavior.

7. The method of claim 1, wherein the connection profile data comprises sensor data associated with an environment.

8. The method of claim 1, wherein the connection profile data comprises data associated with a characteristic of the connection path.

9. The method of claim 1, wherein the remote data comprises audio data.

10. The method of claim 1, wherein the remote data comprises video data.

11. The method of claim 1, wherein detecting the connection path comprises detecting a wireless local area network available to the output device and configured to support the data plane function.

12. The method of claim 1, wherein detecting the connection path comprises detecting a short range local network available to the output device.

13. The method of claim 1, further comprising routing, using the output device, the data plane packet.

14. The method of claim 1, further comprising generating and storing, using the output device, routing data in a table.

15. The method of claim 1, further comprising forwarding, using the output device, the data plane packet.

16. A system, comprising:
a storage configured to store connection profile data; and
a processor configured to receive initiation data from a mobile device, the initiation data configured to initiate an operation associated with remote data, detect an available connection path using an intelligent connection device, determining, using the connection profile data, whether the available connection path is operable to access a data plane packet associated with the remote data from a remote source, determining, using the connection profile data, whether the available connection path is operable to access a control plane packet associated with the remote data from the remote source, and accessing at least one of the data plane packet and the control plane packet from the remote source.

17. The system of claim 16, further comprising a connection learning module configured to generate the connection profile data.

18. The system of claim 17, wherein the connection learning module comprises a connection profile manager configured to access the connection profile data and provide the connection profile data to the intelligent connection device.

19. A computer program product embodied in a computer readable medium and comprising computer instructions for:
receiving, at an output device, initiation data from a mobile device, the initiation data configured to initiate an operation associated with remote data, the mobile device configured to access a data plane packet and a control plane packet associated with the remote data using a cellular network;
detecting a connection path available to the output device using an intelligent connection device coupled to the output device;
determining, using connection profile data, whether the connection path is operable to access the data plane packet from a remote source;
determining, using the connection profile data, whether the connection path is operable to access the control plane packet from the remote source; and
accessing, using the output device, at least one of the data plane packet and the control plane packet.
